(19) United States
(12) Patent Application Publication
(10) Pub. No.: US 2008/0222831 A1
(43) Pub. Date: Sep. 18, 2008

(54) Windshield Wiper Blade Comprising a Two-Part Support Mount

(75) Inventor: Jean-Claude Thienard, Dieppe (FR)

Correspondence Address: OSHA LIANG L.L.P., 1221 MCKINNEY STREET, SUITE 2800, HOUSTON, TX, 77010, US

(73) Assignee: VALEO SYSTEMES D'ESSUYAGE, Le Mesnil-Saint-Denis (FR)

(21) Appl. No.: 12/065,484

(22) PCT Filed: Jul. 27, 2006
(86) PCT No.: PCT/EP2006/007427

§ 371 Date: Feb. 29, 2008

(30) Foreign Application Priority Data
Aug. 29, 2005 (FR) 0508806

(51) Int. Cl. B60S 1/34

(52) U.S. Cl. 15/250.32

(57) ABSTRACT

A windscreen-wiper blade with a longitudinal main orientation includes an element for linking the blade with a driving arm, a longitudinal support frame comprising two longitudinal sections, which is mounted under the linking element and comprises a top tubular body with a longitudinal main axis and bottom means for supporting a windscreen-wiper blade, and a structural element in the shape of a longitudinal blade, which is accommodated inside the tubular body of the support frame. The sections of the frame are arranged longitudinally as an extension of each other so that the inner longitudinal ends are butt-jointed and solidly attached to each other. The solid attachment of the ends of the longitudinal sections of the frame is provided by the linking element.

The invention relates to a windscreen-wiper blade of the “flat blade” type comprising a tubular support frame and an element for linking the blade to a driving arm.

The invention relates more specifically to a windscreen-wiper blade with a longitudinal main orientation comprising an element for linking the blade with a driving arm, a longitudinal support frame, consisting of two longitudinal sections, which is mounted under the linking element and comprises a top tubular body with a longitudinal main axis and bottom means for supporting a windscreen-wiper blade, and a structural element in the form of a longitudinal blade, which is housed inside the tubular body of the support frame.

According to a design that consists of making windscreen-wiper blades with reduced height, the articulated structure of the windscreen-wiper which supports the windscreen-wiper blade is removed, and the association of a hollow support frame with a longitudinal rigidifying spine constitutes the actual structure of the wiper.

The support frame has the shape of a longitudinal profile section and comprises a top tubular body inside which the spine, in the shape of a horizontal longitudinal blade, is accommodated. Finally, the frame comprises a set of bottom hooks for mounting the windscreen-wiper blade.

The spine is made from an elastic material, allowing the windscreen-wiper blade to be pinned against the glass surface to be wiped.

The windscreen-wiper also comprises an element for linking the blade with an arm for driving it in a sweeping movement, under which the support frame is mounted.

According to a known embodiment of the invention, the support frame consists of two longitudinal parts, which are arranged longitudinally on either side of a central part as an integral part of the linking element, which partially delimits the tubular body and which comprises hooks for mounting the blade.

The invention aims to provide another method for manufacturing the support frame.

With this aim, the invention relates to a windscreen-wiper blade as described above, characterised in that the two longitudinal sections of the support frame are arranged longitudinally as an extension of each other and in that the opposing longitudinal ends of the longitudinal sections are butt-jointed and solidly attached to each other by means of the linking element.

According to further characteristics of the invention:
the linking element comprises two bottom tabs that delimit a longitudinal housing in which the inner longitudinal end of each longitudinal section is mounted following a globally longitudinal movement;
the tubular body is delimited at the top by a top wall of each longitudinal section, and the top wall of each longitudinal section comprises an orifice that can accommodate a bottom pin connected to the linking element;
the top wall can deform elastically downwards during the mounting of the inner longitudinal end of the longitudinal section under the linking element, to allow the insertion of the associated pin in the orifice of the top wall;
the structural element is capable of ensuring that the inner longitudinal end of each longitudinal section is locked in its mounted position, the structural element being mounted in the tubular body after the inner longitudinal end of each longitudinal section is mounted under the linking element, and the structural element is able to prevent any elastic deformation of the top wall, to ensure that the inner longitudinal end of the longitudinal section is locked in its mounted position under the linking element.

Further characteristics and advantages of the invention will become apparent from reading the following detailed description, considering the figures appended to facilitate its understanding, in which:

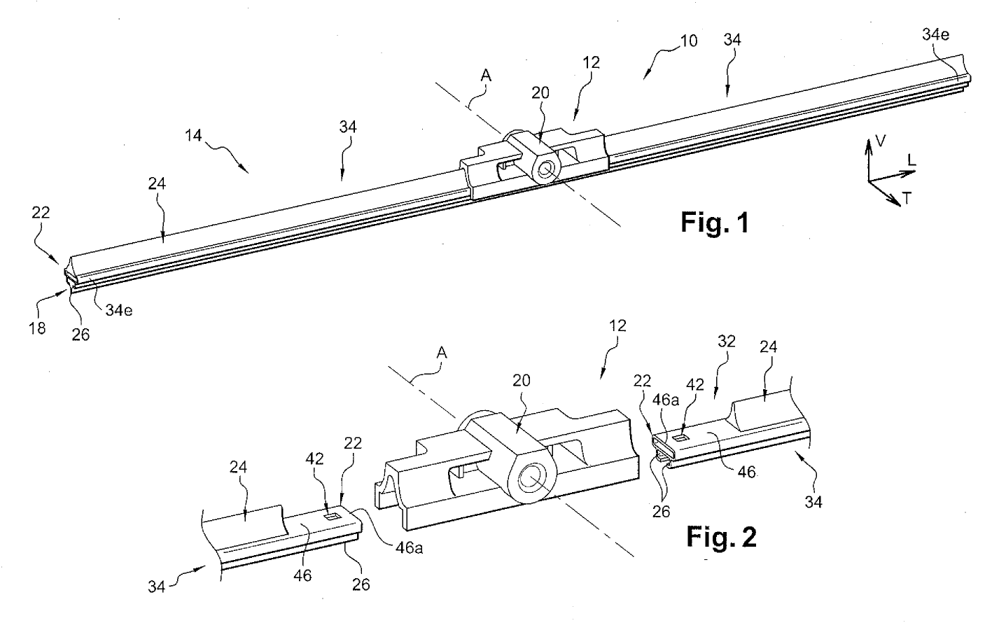

FIG. 1 is a diagrammatic representation in perspective of a windscreen-wiper blade according to the invention;

FIG. 2 is an exploded view in perspective of the blade shown in FIG. 1;

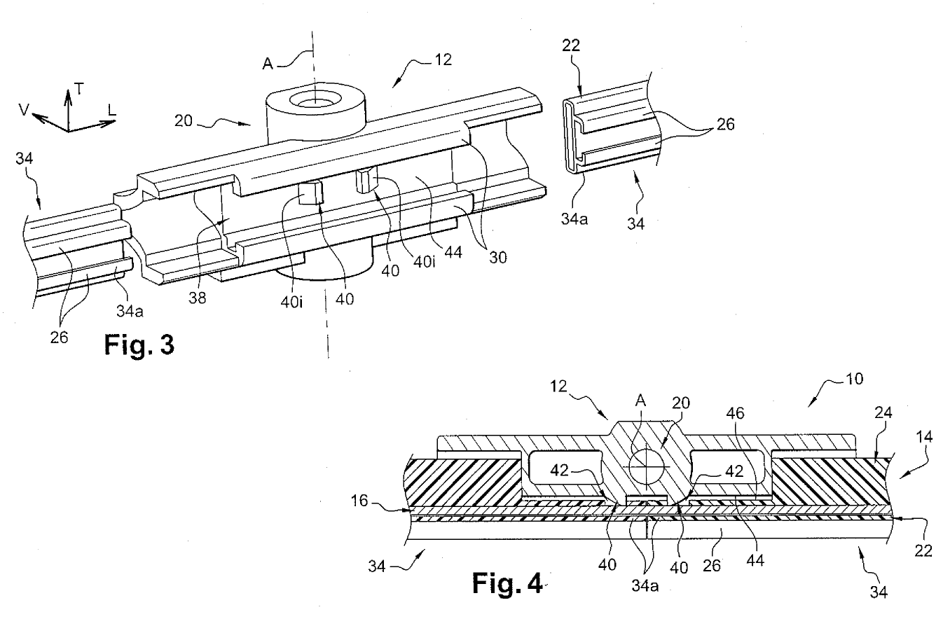

FIG. 3 is a perspective view from below of the blade shown in FIG. 2, showing the pins of the linking element;

FIG. 4 is a section of the blade shown in FIG. 1, along a vertical longitudinal plane.

For the description of the invention, the vertical, longitudinal and transversal directions shall, in a non-exhaustive manner, be marked as V, L and T in the figures.

In the following description, identical, similar or analogous elements will be referred to using the same reference numbers.

The figures show a windscreen-wiper blade 10 of the “flat-blade” type, which comprises an element 12 for linking the blade 10 to a driving arm (not shown), a support frame 14 which is mounted under the linking element 12, a spine 16 (FIG. 4) and a bottom blade 18.

The support frame 14 comprises a tubular central body 22 with a longitudinal main axis, which accommodates the spine 16.

The support frame 14 also comprises bottom means for mounting the windscreen-wiper blade, which consist in this case of two bottom longitudinal hooks 26 placed opposite one another, which delimit a longitudinal housing that opens towards the bottom, in which a top spine that complements the blade 18 is mounted.

Finally, the frame 14 comprises a longitudinal top rib 24 which extends vertically upwards from the central body 22, and which has an aerodynamic shape in order to generate a force that pins the blade 10 against the glass surface, under the action of the relative wind produced by the movement of the vehicle.

The spine 16 constitutes the structural element of the blade 10, which rigidities the frame 14. The spine 16 is made from a relatively rigid material, such as steel, and consists of a longitudinal horizontal blade which is arranged inside the tubular to body 22.

The linking element 12 is arranged overall longitudinally at the centre of the frame 14; it comprises, at its top, means 20 for linking with the driving arm, which make it possible, in particular, to articulate the blade 10 in relation to the arm about a transversal axis A.

The linking element 12 comprises, at the bottom, a set of longitudinal bottom hooks 30, which are distributed on either side of the body 22 of the support frame 14, so that the linking element 12 overlaps the body 22 of the frame 14.

The top rib 24 comprises an opening 32 through which the linking element 12 is mounted on the frame 14.

As can be seen in the figures, the support frame 14 is formed by two longitudinal sections 34, which are arranged longitudinally as an extension of each other, in which the opposing inner longitudinal ends 34a of the two sections 34 are butt-jointed (FIG. 4), in other words, their opposing transversal vertical faces are resting longitudinally against each other.

In this way, each longitudinal section 34 comprises a part of the tubular body 22 accommodating the spine 16, and a part of each hook 26 accommodating the spine of the blade 18.

In addition, the inner longitudinal ends 34a of the longitudinal sections 34 are solidly attached to one another by means of the linking element 12.

As can be seen in greater detail in FIG. 3, the bottom hooks 30 of the linking element 12 delimit a longitudinal housing 38 which is open at its two longitudinal ends, so that the inner end 34a of each longitudinal section 34 is mounted under the linking element 12 following a longitudinal translation movement through the relevant opening of the longitudinal housing 38.

The linking element 12 also comprises means for holding the inner end 34a of each longitudinal section 34 in the longitudinal housing 38, consisting of a pin 40 supported by the linking element, and which is accommodated in the relevant opening 42 of the relevant inner end 34a of a longitudinal section 34.

As can be seen in FIG. 3, each pin 40 projects downwards in relation to a bottom horizontal face 44 of the linking element 12, this horizontal face 44 delimiting the top of the longitudinal housing 38.

As can be seen in FIG. 2, the opening 42 of the inner end 34a of each longitudinal section 34 is made in a top horizontal wall 46 of the longitudinal section 34 which forms the top of the body 22 of the longitudinal section 34, and which is arranged vertically between the spine 16 and the top rib 24 or the bottom face 44 of the linking element 12.

In the embodiment of the invention shown in FIG. 2, the width of the opening 42 is less than the width of the top horizontal wall 46.

According to an alternative embodiment, not shown, the opening 42 extends transversally across the whole width of the top wall 46, in other words, the opening 42 cuts the top wall 46 into two longitudinal sections.

As mentioned previously, the inner end 34a of each longitudinal section 34 is inserted in the longitudinal housing 38 of the linking element 12, following a longitudinal translation movement.

The inner longitudinal end 46a of the top wall 46 is able to deform elastically downwards, in other words, towards the inside of the tubular body 22 when the inner end 34a of the relevant longitudinal section 34 is inserted, and this deformation of the inner end 46a of the top wall 46 is caused by the associated pin 40.

Each pin 40 comprises for this purpose a bottom ramp-shaped section 40i ramp on which the inner end 46a of the top wall 46 can rest towards the top, to facilitate the deformation of the inner end 46a of the top wall 46.

This deformation of the inner end 46a of the top wall 46 facilitates the insertion of the inner end 34a of each longitudinal section 34 in the longitudinal housing 38, until the opening 42 of the inner end 46a of the top wall 46 is located at the level of the associated pin 40. The pin 40 then enters the opening 42, and the top wall 46 elastically returns to its original flat shape. The inner end 34a of the longitudinal section 34 is then in its mounted position under the linking element 12.

According to a preferred embodiment of the invention, the spine 16 is mounted in the tubular body 22 after the two sections 34 are mounted under the linking element 12. In addition, the spine 16 is shaped so that, when it is in its mounted position in the tubular body 22, it rests towards the top against an opposing bottom face of the top wall 46 of each longitudinal section 34.

In this way, the spine prevents the inner end 46a of the top wall 46 from deforming downwards under the action of the associated pin 40. The spine 16 therefore ensures that the inner end 46a of the top wall 46 is locked in its mounted position under the linking element 12.

The blade 10 also comprises other means, not shown, for longitudinally locking the spine 16 in its mounted position in the tubular body 22, which are preferably arranged at the level of the outer longitudinal end 34e of each longitudinal section.

1. Windscreen-wiper blade with a longitudinal main orientation, comprising:
an element for linking the blade with a driving arm;
a longitudinal support frame comprising consisting two longitudinal sections, which is mounted under the linking element and comprises a top tubular body with a longitudinal main axis and bottom means for supporting a windscreen-wiper blade; and
a structural element in the shape of a longitudinal blade, which is accommodated inside the tubular body of the support frame, the sections of the frame being arranged longitudinally as an extension of each other so that the inner longitudinal ends are butt-jointed and solidly attached to each other,
wherein the solid attachment of the ends of the longitudinal sections of the frame is provided by the linking element.

2. Blade according to claim 1 wherein the linking element comprises two bottom tabs that delimit a longitudinal housing in which the inner longitudinal end of each longitudinal section is mounted following an overall longitudinal movement.

3. Blade according to claim 1, in which the tubular body is delimited at the top by a top wall of each longitudinal section,
wherein the top wall of each longitudinal section comprises an orifice that accommodates a bottom pin associated with the linking element.

4. Blade according to claim 3 wherein the top wall is capable of deforming elastically downwards while the inner longitudinal end of the longitudinal section is being mounted under the linking element, to allow the insertion of the associated pin in the orifice of the top wall.

5. Blade according to claim 1, wherein the structural element can ensure that the inner longitudinal end of each longitudinal section is locked in its mounted position under the linking element.

6. Blade according to claim 4,
wherein the structural element is mounted in the tubular body after the inner longitudinal end of each longitudinal section is mounted under the linking element, and
wherein the structural element is capable of preventing any elastic deformation of the top wall, to ensure the locking of the inner longitudinal end of the longitudinal section in its mounted position under the linking element.

7. Blade according to claim 2, in which the tubular body is delimited at the top by a top wall of each longitudinal section,
wherein the top wall of each longitudinal section comprises an orifice that accommodates a bottom pin associated with the linking element.

8. Blade according to claim 2, wherein the structural element can ensure that the inner longitudinal end of each longitudinal section is locked in its mounted position under the linking element.

9. Blade according to claim 3, wherein the structural element can ensure that the inner longitudinal end of each longitudinal section is locked in its mounted position under the linking element.

10. Blade according to claim 4, wherein the structural element can ensure that the inner longitudinal end of each longitudinal section is locked in its mounted position under the linking element.

11. Blade according to claim 5,
wherein the structural element is mounted in the tubular body after the inner longitudinal end of each longitudinal section is mounted under the linking element, and
wherein the structural element is capable of preventing any elastic deformation of the top wall, to ensure the locking of the inner longitudinal end of the longitudinal section in its mounted position under the linking element.

12. Blade according to claim 7, wherein the top wall is capable of deforming elastically downwards while the inner longitudinal end of the longitudinal section is being mounted under the linking element, to allow the insertion of the associated pin in the orifice of the top wall.

13. Blade according to claim 7, wherein the structural element can ensure that the inner longitudinal end of each longitudinal section is locked in its mounted position under the linking element.

14. Blade according to claim 10,
wherein the structural element is mounted in the tubular body after the inner longitudinal end of each longitudinal section is mounted under the linking element, and
wherein the structural element is capable of preventing any elastic deformation of the top wall, to ensure the locking of the inner longitudinal end of the longitudinal section in its mounted position under the linking element.

15. Blade according to claim 12, wherein the structural element can ensure that the inner longitudinal end of each longitudinal section is locked in its mounted position under the linking element.

16. Blade according to claim 15,
wherein the structural element is mounted in the tubular body after the inner longitudinal end of each longitudinal section is mounted under the linking element, and
wherein the structural element is capable of preventing any elastic deformation of the top wall, to ensure the locking of the inner longitudinal end of the longitudinal section in its mounted position under the linking element.
